(19) United States
(12) Patent Application Publication
(10) Pub. No.: US 2026/0310731 A1
(43) Pub. Date: Oct. 8, 2026

(54) METHOD AND SYSTEM FOR PERFORMING ENTITY RESOLUTION

(71) Applicant: JPMorgan Chase Bank, N.A., New York, NY (US)

(72) Inventors: Simant KUMAR, Bengaluru (IN); Ranjan MONDAL, Rampurhat (IN); Gaurav KARKAL, Bangalore (IN); Radha JAYARAMAN, Gautam Buddha Nagar (IN); Abhishek MITRA, Bangalore (IN)

(73) Assignee: JPMorgan Chase Bank, N.A., New York, NY (US)

(21) Appl. No.: 19/213,710

(22) Filed: May 20, 2025

(30) Foreign Application Priority Data
Apr. 4, 2025 (IN) 202511033413

(51) Int. Cl. G06F 16/906

(52) U.S. Cl. CPC G06F 16/906

(57) ABSTRACT

A method and system for performing entity resolution are disclosed. The method includes extracting a first set of attributes and a second set of attributes from a received set of data. The method further includes generating a first set of embeddings and a second set of embeddings. The method further includes storing the generated first set of embeddings and the second set of embeddings in a database. The method further includes selecting a target entity from the set of entities. The method further includes comparing a set of target embeddings associated with the target entity with the stored first and the stored second set of embeddings. Thereafter, the method includes clustering, a set of candidate entities based on the comparing.

### CROSS-REFERENCE TO RELATED APPLICATIONS

This application claims priority benefit from Indian Application No. 202511033413, filed on Apr. 4, 2025, in the India Patent Office, which is hereby incorporated by reference in its entirety.

### FIELD OF THE DISCLOSURE

The present disclosure relates to record linkage or data matching. More particularly the present disclosure relates to a method and system for performing entity resolution.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Entity determination or resolution is a process of identifying and representing a specific name, object, company, person, or item uniquely, precisely, and completely from a data perspective. It involves recognizing and resolving multiple occurrences of an entity across different sources, as well as addressing the issue of multiple versions of the correct information. During implementation, different data providers provide source data with varying data schemas and data fill rate. Therefore, there is a need to find data records that represent the same entity based on their attributes. Further, there is a possibility that all attributes would not be available for all records. The general process for resolving such discrete data records into a single record view for the entity is referred to as entity resolution.

The conventional methods and systems use all possible attributes from each of the data records and match them through several permutations at pairwise record level. However, such a process is complex and inefficient with respect to scalability and performance. Further, the data records come with different mixed modalities, formats, sparsity, standardization, and hierarchical linkage which makes it more challenging and complex to manage and process data records in a cost efficient and optimized manner. Moreover, there remains a big challenge related to scale of comparison required to compare a record with another, which is prohibitively expensive at a large scale.

Hence, in view of these and other existing limitations, there arises an imperative need to provide an efficient solution to overcome the above-mentioned limitations and to provide a method and system for performing entity resolution.

### SUMMARY

The present disclosure, through one or more of its various aspects, embodiments, and/or specific features or sub-components, provides, inter alias, various systems, servers, devices, methods, media, programs, and platforms to resolve named entity deduplication.

According to an aspect of the present disclosure, a method for performing entity resolution is disclosed. The method is implemented by at least one processor. The method includes receiving, by the at least one processor, a set of data from at least one data source, wherein the set of data comprises a plurality of attributes associated with a set of entities. The method further includes extracting, by the at least one processor, a first set of attributes and a second set of attributes from the plurality of attributes, wherein each attribute from the first set of attributes is associated with at least one attribute from the second set of attributes. The method further includes generating, by the at least one processor using at least one trained model, a first set of embeddings for the first set of attributes and a second set of embeddings for the second set of attributes. The method further includes storing, by the at least one processor, the generated first set of embeddings and the generated second set of embeddings in a database. The method further includes selecting, by the at least one processor, a target entity from the set of entities. The method further includes identifying, by the at least one processor, a target set of embeddings associated with the selected target entity, from the stored first set of embeddings and the second set of embeddings. Further, the method includes comparing, by the at least one processor, the target set of embeddings with each of the stored first set of embeddings and each of the stored second set of embeddings. Finally, the method includes clustering, by the at least one processor, a set of candidate entities based on comparing.

In accordance with an exemplary embodiment, the set of data may comprise a plurality of bibliographic details of the set of entities.

In accordance with an exemplary embodiment, the generated first set of embeddings may be combined with a corresponding set of embeddings from the second set of embeddings prior to storing in the database.

In accordance with an exemplary embodiment, a set of relevant candidate entities may be determined from the set of candidate entities using an agent framework that is configured based on large language models (LLMs) and ranking, the set of relevant candidate entities using the agent framework.

In accordance with an exemplary embodiment, a similarity score for each relevant candidate entity may be displayed from the ranked set of relevant candidate entities.

In accordance with an exemplary embodiment, the first set of attributes may comprise at least one from among a company name, an address, and a uniform resource locator (URL).

In accordance with an exemplary embodiment, the second set of attributes may comprise at least one from among a location, a ZIP code, a city, a state, and a country.

In accordance with an exemplary embodiment, the at least one trained model may further comprise a first trained model that may be trained using historical data of the first set of attributes and a second trained model that may be trained using historical data of the second set of attributes.

According to another aspect of the present disclosure, a computing device configured to implement an execution of a method to perform entity resolution is disclosed. The computing device includes a processor; a memory storing instructions; and a communication interface coupled to each of the processor and the memory. The processor is programmed to cooperate with the instructions to perform operations that comprise receiving a set of data from at least one data source, wherein the set of data comprises a plurality of attributes associated with a set of entities. The operations further comprise extracting a first set of attributes and a second set of attributes from the plurality of attributes, wherein each attribute from the first set of attributes is associated with at least one attribute from the second set of attributes. to the operations may further comprise generating using at least one trained model, a first set of embeddings for the first set of attributes and a second set of embeddings for the second set of attributes. The operations may further comprise storing the generated first set of embeddings and the generated second set of embeddings in a database. The operations may further comprise selecting a target entity from the set of entities. The operations may further comprise identifying a target set of embeddings associated with the selected target entity, from the stored first set of embeddings and the second set of embeddings. The operations may further comprise comparing the target set of embeddings with each of the stored first set of embeddings and each of the stored second set of embeddings. The operations may further comprise clustering a set of candidate entities based on the comparing.

In accordance with an exemplary embodiment, the set of data may comprise a plurality of bibliographic details of the set of entities.

In accordance with an exemplary embodiment, the generated first set of embeddings may be combined with a corresponding set of embeddings from the second set of embeddings prior to storing in the database.

In accordance with an exemplary embodiment, a set of relevant candidate entities may be determined from the set of candidate entities using an agent framework that is configured based on LLMs and ranking the set of relevant candidate entities using the agent framework.

In accordance with an exemplary embodiment, a similarity score for each relevant candidate entity may be displayed from the ranked set of relevant candidate entities.

In accordance with an exemplary embodiment, the first set of attributes may comprise at least one from among a company name, an address, and a URL.

In accordance with an exemplary embodiment, the second set of attributes may comprise at least one from among a location, a ZIP code, a city, a state, and a country.

In accordance with an exemplary embodiment, the at least one trained model may further comprise a first trained model that may be trained using historical data of the first set of attributes and a second trained model that may be trained using historical data of the second set of attributes.

According to yet another aspect of the present disclosure, a non-transitory computer-readable storage medium storing instructions to perform entity resolution is disclosed. The instructions include executable code which, when executed by a processor, may cause the processor to receive a set of data from at least one data source, wherein the set of data comprises a plurality of attributes associated with a set of entities; extract a first set of attributes and a second set of attributes from the plurality of attributes, wherein each attribute from the first set of attributes is associated with at least one attribute from the second set of attributes; generate using at least one trained model, a first set of embeddings for the first set of attributes and a second set of embeddings for the second set of attributes; store the generated first set of embeddings and the generated second set of embeddings in a database; select a target entity from the set of entities, wherein the target entity is associated with a set of target embeddings; identify a target set of embeddings associated with the selected target entity, from the stored first set of embeddings and the stored second set of embeddings; compare the target set of embeddings with each of the stored first set of embeddings and each of the stored second set of embeddings; cluster a set of candidate entities based on the comparing.

In accordance with an exemplary embodiment, the set of data may comprise a plurality of bibliographic details of the set of entities.

In accordance with an exemplary embodiment, the generated first set of embeddings may be combined with a corresponding set of embeddings from the second set of embeddings prior to storing in the database.

In accordance with an exemplary embodiment, a set of relevant candidate entities may be determined from the set of candidate entities using an agent framework that is configured based on LLMs and ranking the set of relevant candidate entities using the agent framework.

In accordance with an exemplary embodiment, a similarity score for each relevant candidate entity may be displayed from the ranked set of relevant candidate entities.

In accordance with an exemplary embodiment, the first set of attributes may comprise at least one from among a company name, an address, and a URL.

In accordance with an exemplary embodiment, the second set of attributes may comprise at least one from among a location, a ZIP code, a city, a state, and a country.

In accordance with an exemplary embodiment, the at least one trained model may further comprise a first trained model that may be trained using historical data of the first set of attributes and a second trained model that may be trained using historical data of the second set of attributes.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for performing entity resolution, in accordance with an exemplary embodiment of the present disclosure.

FIG. 2 illustrates an exemplary diagram of a network environment for performing entity resolution, in accordance with an exemplary embodiment of the present disclosure.

FIG. 3 illustrates an exemplary system for performing entity resolution, in accordance with an exemplary embodiment of the present disclosure.

FIG. 4 illustrates an exemplary method flow diagram for performing entity resolution, in accordance with an exemplary embodiment of the present disclosure.

FIG. 5 illustrates a process flow for performing entity resolution, in accordance with an exemplary embodiment of the present disclosure.

FIG. 6 illustrates an architecture for training a neural network model for generating embeddings, in accordance with an exemplary embodiment of the present disclosure.

### DETAILED DESCRIPTION

Exemplary embodiments will now be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of systems or products that offer precise and efficient solutions for resolving named entity deduplication. While various resolving technologies exist for named entity recognition and deduplication, they often fall short due to complexity and higher resource computation. For example, when a data record is present with mixed modalities such as tabular data with columns containing numeric, categorical, and textual data, it poses a complex situation to a named entity recognition (NER) tool on how to treat different modalities. Further, when the data records are in sparsity, it also creates a challenging situation for the NER tool on how to compare matching strength of data records against one another, when the number of attributes to match vary from pair to pair. Another challenge for the existing solutions is how to handle data standardization. Different data sources have different levels of standardization of data, and it becomes quite difficult when it involves textual content. For example, “JPMCB NA” is the same entity as “J.P. Morgan Chase Bank, National Association” but conventional techniques and solutions may fail to account for it. Further, existing solutions face challenges in handling hierarchy of linkages among the data records. For example, “JPMSIPL” is a subsidiary of “JPMCB NA”, but they could potentially share many common attributes including office location, CEO, industry tag, telephone number etc. In such a scenario, it is a challenging task to address the nuances of hierarchy. Furthermore, among several such other challenges, there also remains a big challenge in scale of the record-to-record comparisons. To identify potential matches, comparing one record with every other record across sources could be prohibitively expensive on a large scale.

The present disclosure solves the aforementioned problems by providing a method and a system to perform entity resolution. In the present disclosure, at first, the system receives a set of data from at least one source. The set of data comprises a plurality of attributes associated with a set of entities. Further, the system extracts a first set of attributes and a second set of attributes from the plurality of attributes, wherein each attribute from the first set of attributes is associated with at least one attribute from the second set of attributes. Further, the system generates, using at least one trained model, a first set of embeddings for the first set of attributes and a second set of embeddings for the second set of attributes. Further, the system stores the generated first set of embeddings and the generated second set of embeddings in a database. Further, the system selects a target entity from the set of entities. Further, the system identifies a set of embeddings associated with the selected target entity, from the stored first set of embeddings and the stored second set of embeddings. Further, the system compares the set of embeddings associated with the target entity with each of the stored first set of embeddings and each of the stored second set of embeddings. Thereafter, the system clusters a set of candidate entities based on the comparison.

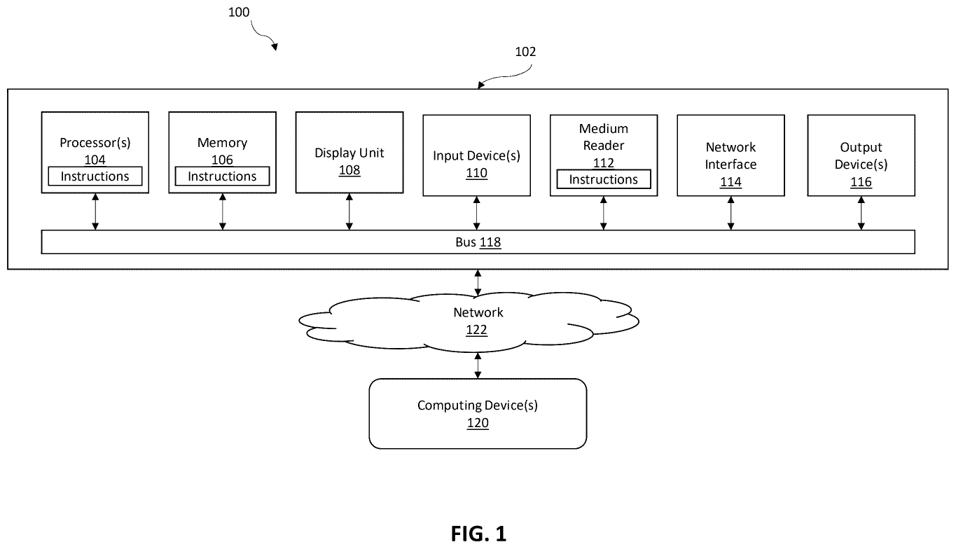

FIG. 1 is an exemplary system for use in accordance with the embodiments described herein. The system 100 may include a computer system 102 The term “computer system” may also be referred to as “computing device” and such phrases/terms can be used interchangeably in the specifications.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to perform entity resolution.

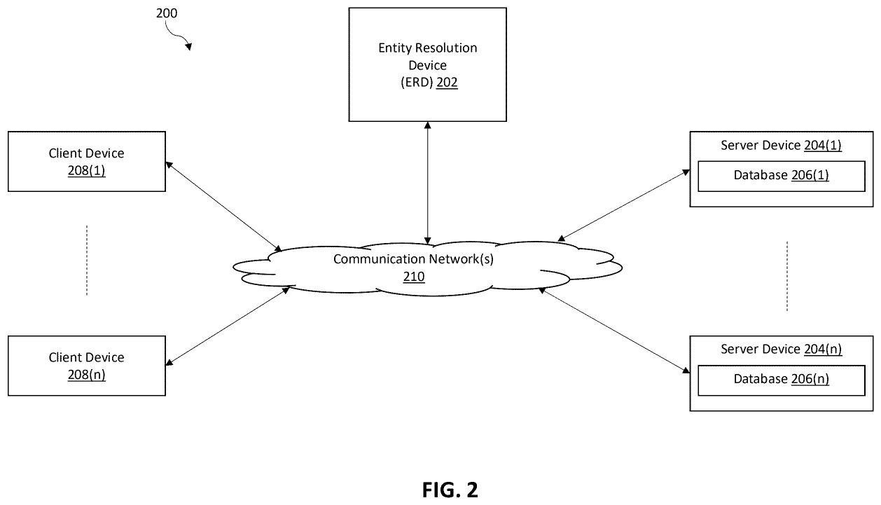

Referring to FIG. 2, a schematic of an exemplary network environment 200 for performing entity resolution is illustrated. In an exemplary embodiment, the method is executable on any networked computer platform, such as, for example, a personal computer (PC).

The method to perform entity resolution may be executed by an entity resolution device (ERD) 202. The ERD 202 may be the same or similar to the computer system 102 as described with respect to FIG. 1. The ERD 202 may store one or more applications that may include executable instructions that, when executed by the ERD 202, cause the ERD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the ERD 202 itself, may be located in the virtual server(s) running in a cloud-based computing environment rather than being tied to one or more specific physical network computing devices. Also, the application(s) may be running in one or more virtual machines (VMs) executing on the ERD 202. Additionally, in one or more embodiments of this technology, virtual machine(s) running on the ERD 202 may be managed or supervised by a hypervisor.

In the network environment 200 of FIG. 2, the ERD 202 is coupled to a plurality of server devices 204(1)-204(n) that host a plurality of databases 206(1)-206(n), and also to a plurality of client devices 208(1)-208(n) via communication network(s) 210. A communication interface of the ERD 202, such as the network interface 114 of the computer system 102 of FIG. 1, operatively couples and communicates between the ERD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ERD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ERDs that efficiently implement the method to perform entity resolution.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The ERD 202 may be a standalone device or integrated with one or more other devices or apparatuses, such as one or more of the server devices 204(1)-204(n), for example. In one particular example, the ERD 202 may include or be hosted by one of the server devices 204(1)-204(n), and other arrangements are also possible. Moreover, one or more of the devices of the ERD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ERD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to entity information, attributes, processed embeddings, trained models, rules, and instructions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ERD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the ERD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the ERD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ERD 202, the server devices 204(1)-204(n), or the client devices 208(1)-208(n), for example, may be configured to operate as virtual instances on the same physical machine. In other words, one or more of the ERD 202, the server devices 204(1)-204(n), or the client devices 208(1)-208(n) may operate on the same physical device rather than as separate devices communicating through communication network(s) 210. Additionally, there may be more or fewer ERDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

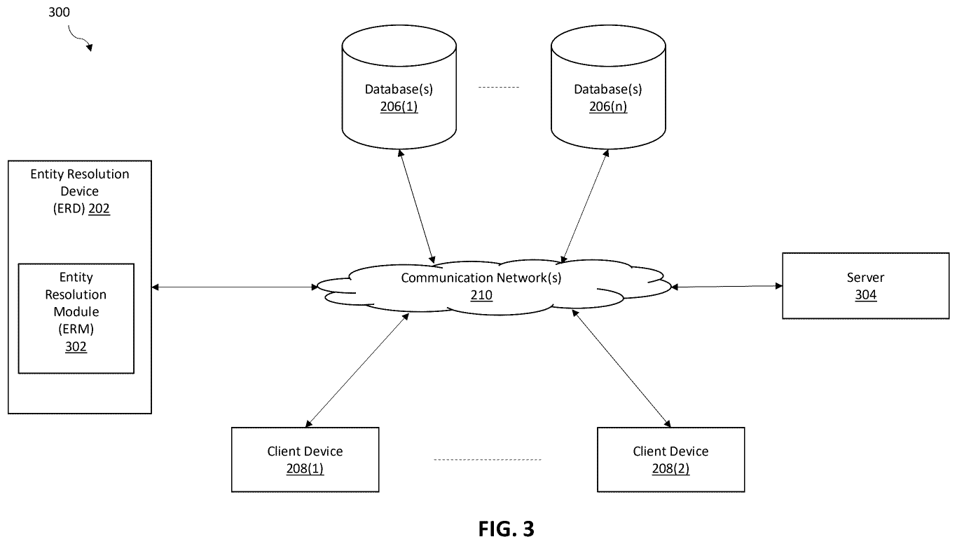

FIG. 3 illustrates a system diagram for implementing a method to perform entity resolution, in accordance with an exemplary embodiment.

As illustrated in FIG. 3, the system 300 may include an ERD 202 within which an entity resolution module (ERM) 302 is embedded, a server 304, a database(s) 206(1) . . . 206(n), a plurality of client devices 208(1) . . . 208(2), and a communication network(s) 210.

According to exemplary embodiments, the ERD 202 including the ERM 302 may be connected to the server 304, and the database(s) 206(1) . . . 206(n) via the communication network(s) 210, but the disclosure is not limited thereto. The ERD 202 may also be connected to the plurality of client devices 208(1) . . . 208(2) via the communication network 210, but the disclosure is not limited thereto. The database(s) 206(1) . . . 206(n) may include a rule database.

In an embodiment, the ERD 202 is described and shown in FIG. 3 as including the ERM 302, although it may include other rules, policies, modules, databases, or applications, for example. As will be described below, the ERM 302 is configured to implement a method to perform entity resolution.

An exemplary system 300 for implementing a mechanism to perform entity resolution by utilizing the network environment of FIG. 2 is shown as being executed in FIG. 3. Specifically, a first client device 208(1) and a second client device 208(2) are illustrated as being in communication with the ERD 202. In this regard, the first client device 208(1) and the second client device 208(2) may be “clients” of the ERD 202 and are described herein as such. Nevertheless, it is to be known and understood that the first client device 208(1) and/or the second client device 208(2) need not necessarily be “clients” of the ERD 202, or any entity described in association therewith herein. Any additional or alternative relationship may exist between either or both of the first client device 208(1) and the second client device 208(2) and the ERD 202, or no relationship may exist.

Further, the ERD 202 is illustrated as being able to access one or more databases 206(1) . . . 206(n). The ERM 302 may be configured to access these repositories/databases for implementing a method to resolve a named entity deduplication. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the ERD 202 via broadband or cellular communication. These embodiments are merely exemplary and are not limiting or exhaustive.

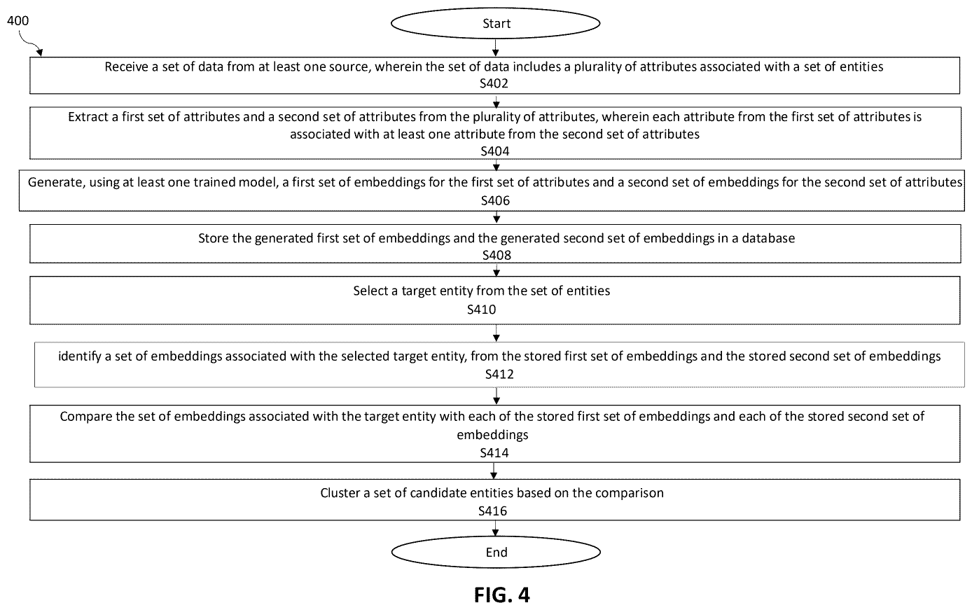

Referring to FIG. 4, an exemplary method 400 is shown to perform entity resolution, in accordance with an exemplary implementation. As shown in FIG. 4, the method 400 begins following a need to provide entity resolution for identifying and making a cluster of a same entity (e.g., company) in a single view and display while avoiding any ambiguity for mismatch or wrong identification of the same entity. For example, IBM and International Business Machine represent the same entity (company). The method 400 identifies them and puts them in a single-view cluster of identified entities (e.g., company-IBM). The method 400 is implemented by at least one processor 104.

At step S402, the method 400 includes receiving, by the at least one processor 104, a set of data from at least one data source. The set of data comprises a plurality of attributes associated with a set of entities. In an exemplary implementation, the set of data consists of data records sourced from various data origins.

Example of ‘entity’ or ‘entities’ herein may include such as, but not limited to, a company, a person, an object, and an item. In an embodiment, the set of data may include a plurality of bibliographic details of the set of entities, such as name, address, email ID, etc.

The method 400 for performing entity resolution may receive the set of data from at least one data source, which may be an external source or an internal source. The external data sources may include third-party data provider terminals, which may include leading financial data operators across the world. Further, the internal sources may be data providers within an organization, an enterprise, and a network. In an exemplary implementation, the at least one data source provides the set of data for the set of entities (e.g., set of companies) such as company names, address, URLs, location of the company, ZIP, city, state, and country. In another exemplary implementation, the at least one data source may provide the set of data for the set of entities (e.g., set of persons), such as person name, address, location, city, and state.

At step S404, the method 400 includes extracting, by the at least one processor 104, a first set of attributes and a second set of attributes from the plurality of attributes. In an embodiment, each attribute from the first set of attributes is associated with at least one attribute from the second set of attributes.

In an exemplary implementation, the processor 104 may extract from the received set of data comprising the plurality of attributes, at least two sets of attributes. The first set of attributes, representing textual attributes, may include such as, but not limited to, company details such as, company name, address, and URL. The second set of attributes, representing categorical attributes, may include such as, but not limited to, a location, a ZIP code, a city, a state, and a country for the company. In an exemplary implementation, the first set of attributes may represent textual attributes, and the second set of attributes may represent categorical attributes. Textual attributes may refer to any text-based data associated with the set of entities, such as company names, addresses, or URLs. These attributes often vary in length and content, making them challenging to compare directly. The categorical attributes are easy to compare as they have standard text-based data.

Further, each attribute from the extracted first set of attributes is associated with at least one attribute from the second set of attributes and corresponds to the same entity. For example, for an entity (e.g., a company named ‘3× Lighthouse’) the extracted set of attributes may be as given below:
First set of attributes: 3× Lighthouse (name)−3×lighth.com (URL), 16 Mitchell Rd (address)
Second set of attributes: 01938 (zip), Ipswich (city), MA (state), USA (country)

As illustrated in the above example, the first set of attributes and the second set of attributes are associated with each other and correspond to the same entity (e.g., 3× Lighthouse).

It will be appreciated by the person skilled in the art that the mentioned attributes are given for exemplary purposes, there may be similar or other attributes based on similar implementations.

At step S406, the method 400 includes generating, by the at least one processor 104, using at least one trained model, a first set of embeddings for the first set of attributes and a second set of embeddings for the second set of attributes. To handle the mixed-modal nature of the data (i.e., numeric, categorical, and textual), the method 400 involves creating an embedding for both textual and categorical attributes. In an exemplary implementation, graph node embeddings are used for categorical data, while textual embeddings are used for textual data. These graph node embeddings and textual embeddings transform the data into a uniform representation, making it easier to compare data records. Further, even when some attributes are missing in the set of data, the embeddings process ensures that a dense representation is generated using the available attributes. For example, for missing categorical attributes, default or imputed values may be used to fill in gaps, allowing the at least one trained model to still generate meaningful embeddings. The embedding process may be designed to handle partial data, where only the available attributes contribute to the embeddings. This ensures that the absence of certain attributes does not prevent the creation of a complete representation. Techniques like normalization and scaling may be applied to ensure that the influence of missing attributes is minimized, allowing the available data to dominate the embeddings process.

In an exemplary implementation, the processor 104 may generate the first set of embeddings and the second set of embeddings for the extracted set of attributes using the at least one trained model. In an exemplary implementation, the at least one trained model is a machine learning-based or artificial intelligence-based trained model. The first set of embeddings and the second set of embeddings herein may represent conversion of received textual data into a tokenized numeric data using the trained model. The processor 104 generates the first set of embeddings for the first set of attributes (e.g., textual data) and the second set of embeddings for the second set of attributes (categorical or location data). The first set of embeddings and the second set of embeddings may have a unique identification (ID) number for identifying the relevant embeddings. These embeddings represent the relationships and similarities between different categorical values in a uniform vector space.

In an exemplary implementation, the at least one trained model further comprises a first trained model that is trained using historical data of the first set of attributes and a second trained model that is trained using historical data of the second set of attributes. The first trained model may be trained using historical data of the first set of attributes such as with a company name, an address, and a URL. In an example, the first trained model is trained for recognizing the company name, address, and URL. In another example, the first trained model may be trained for recognizing the person's name and address. For textual attributes (e.g., company name and address), textual embeddings are generated using the first trained model, which may include, but not limited to, natural language processing (NLP) based model, a sequential model, and a Siamese neural network model. These embeddings capture the semantic meaning of the text, allowing for effective comparison even when the text varies in length or content.

The second trained model may be trained using historical data of the second set of attributes such as with a location, a ZIP code, a city, a state, and a country. In an example, the second trained model may be trained for recognizing the entity's location, such as, ZIP code, city, state, and country. For categorical attributes, graph node embeddings are created using a graph neural network (GNN) model.

At step S408, the method 400 includes storing, by the at least one processor 104, the generated first set of embeddings and the generated second set of embeddings in a database. In an exemplary implementation, the processor 104 combines the generated first set of embeddings with the corresponding second set of embeddings prior to storing in the database. In an exemplary implementation, the database may be a vector database. After combining the first set of embeddings and second set of embeddings, the combined embeddings represent the corresponding entity. The creation of combined embeddings involves synthesizing categorical and textual embeddings into a single and robust representation. By effectively handling missing attributes and leveraging the strengths of multiple data modalities, the combined embeddings ensure that the entity resolution process remains accurate and reliable, even in the face of incomplete data.

In an exemplary implementation, the processor 104 stores the first set of embeddings and the second set of embeddings in the combined form in the database. This results in forming a combined embedding. For example, the combined embeddings may be stored in a vector database, such as OpenSearch, Faiss®, and OpenSearch®, which support efficient retrieval using Approximate Nearest Neighbor (ANN) search techniques. ANN search is designed to quickly find data records/combined embeddings that are similar to a given query/target embedding, even in datasets with billions of records. This is achieved by comparing the embeddings and identifying those that are closest in the vector space. The combined embeddings serve as a powerful tool for comparing and matching entities across different data sources. By integrating both categorical and textual information, the method 400 provides a nuanced and comprehensive representation that enhances the accuracy of the entity resolution process.

In an exemplary implementation, the combined embeddings may be created by synthesizing the categorical and textual embeddings into a single vector representation. This synthesis involves assigning weights to each type of embedding based on their importance or relevance to the entity resolution task. The weighting can be adjusted to emphasize certain attributes over others, thereby allowing the combined embeddings to reflect the most critical features of the entity.

At step S410, the method 400 includes selecting, by the at least one processor 104, a target entity from the set of entities. In an exemplary implementation, the processor 104 automatically selects the target entity from the set of entities in a random manner. In an exemplary implementation, the processor 104 may also select the target entity based on a manual input. For example, the processor 104 may select ‘Advanced Precision Engineering Inc’ as a target entity from the set of entities which may include, but not limited to, ‘APE’, ‘Advanced Precision Engg’ and the like. The processor 104 may assign a unique identification number to identify the target entity.

At step S412, the method 400 includes identifying, by the at least one processor 104, a set of embeddings associated with the selected target entity, from the stored first set of embeddings and the stored second set of embeddings. In an exemplary implementation, the set of embeddings associated with the target entity are retrieved from the database storing the first set of embeddings and the second set of embeddings.

At step S414, the method 400 includes comparing, by the at least one processor 104, the set of embeddings associated with the target entity with each of the stored first set of embeddings and each of the stored second set of embeddings. In an exemplary implementation, when a new record (e.g., the target entity) needs to be resolved, its embeddings are compared against the stored embeddings (the first set of embeddings and the second set of embeddings) using ANN search techniques.

In an exemplary implementation, the processor 104 retrieves the set of embeddings associated with the target entity. After retrieving the set of embeddings, the processor 104 further retrieves the stored first set of embeddings (e.g., company name, address, and URL) and the stored second set of embeddings (e.g., location, ZIP code, city, state, and country) from the database (e.g., vector database) and performs comparison to identify similar embeddings corresponding to the set of embeddings associated with the target entity.

In an exemplary implementation, the processor 104 may perform ANN search in the database to perform the retrieving and comparison to find out similar embeddings for the set of embeddings associated with the target entity.

At step S416, the method 400 includes clustering, by the at least one processor 104, a set of candidate entities based on the comparing. In an exemplary implementation, after comparing the set of embeddings associated with the target entity with each of the stored first set of embeddings and the stored second set of embeddings, the processor 104 forms a cluster or group of candidate entities having similar embeddings with the target entity. In the context of the entity resolution process, a candidate entity refers to a potential match for the given target entity. The goal is to identify data records from various data sources that might represent the same real-world entity, such as a company, person, or product. For example, if the task is to resolve a company record, candidate entities would be other company records from various data sources that share similar attributes with the target entity. These candidates are selected based on their proximity in the embeddings, as determined by the ANN search. In an example, for a target entity, ‘Advanced Precision Engineering Inc’, the processor 104 forms a cluster of similar candidate entities may be, such as, ‘AP Engineering Inc’, ‘APE’, ‘Advanced Precision’, ‘AP Engg Ltd.’, ‘ADVANCED PRECISION ENGINEERING’, etc.

In an exemplary implementation, the method 400 further comprises determining a set of relevant candidate entities from the set of candidate entities using an agent framework that is configured based on LLMs. The method further comprises ranking, the set of relevant candidate entities using the agent framework. The determination of relevant candidate entities is a refinement step that involves deploying multiple LLM-powered agents, each guided by predefined rules and instructions. These agents capture intrinsic nuances and distinctions, such as aliases and hierarchical relationships, ensuring a more precise and relevant set of candidate entities. This way, the refinement and the ranking process is a sophisticated approach to entity resolution that leverages advanced techniques in embeddings, ANN search, and LLM-powered decision-making. By breaking the task into two distinct steps, the method 400 may efficiently handle large-scale, mixed-modal data while maintaining high precision.

In an exemplary implementation, the method 400 further comprises displaying a similarity score for each relevant candidate entity from the ranked set of relevant candidate entities. The similarity score is a numerical value that indicates how similar the target entity is to the relevant candidate entity. A higher similarity score suggests that the two are more similar.

In an exemplary implementation, after determining the relevant candidate entities, the processor 104, is configured to display relevant candidate entities for the set of clustered candidate entities. For example, the below tables for the target entity (e.g., given or searched), such as ‘Advanced Precision Engineering Inc’ shows the relevant entities for resolving the entity duplication or repetition.

TABLE 1a

| | Name | Address | URL | ZIP | City | State | Country |
|---|---|---|---|---|---|---|---|
| Target | Advanced | 16 | Ape10.com | 01938 | Ipswich | MA | USA |
| Entity | Precision | Mitchell | | | | | |
| | Engineering | Rd | | | | | |
| | Inc | | | | | | |

TABLE 1b

| | Name | Address | URL | ZIP | City | State | Country |
|---|---|---|---|---|---|---|---|
| Relevant/ | Advanced | 16 | | 01938 | Ipswich | MA | USA |
| Candidate | Precision Engg | Mitchell | | | | | |
| Entities | | Rd | | | | | |
| | Advanced | 16 | | 01938 | Ipswich | MA | USA |
| | Precision | Mitchell | | | | | |
| | | Rd | | | | | |
| | APE | 16 | ape10.com | 01938 | Ipswich | MA | USA |
| | | Mitchell | | | | | |
| | | Rd | | | | | |
| | Advanced | 16 | ape10.com | | Ipswich | MA | USA |
| | Precision | Mitchell | | | | | |
| | Engineering | Rd | | | | | |
| | Incorporation | | | | | | |
| | AP Engineering | | ape10.com | | Ipswich | MA | USA |
| | Inc | | | | | | |
| | ADVANCED | | | | Ipswich | MA | USA |
| | PRECISION | | | | | | |
| | ENGINEERING | | | | | | |

As shown, both tables (Table 1a and Table 1b) are associated with the same target entity, ‘Advanced Precision Engineering Inc’. The processor 104 is configured to determine single-view representation for the same target entity.

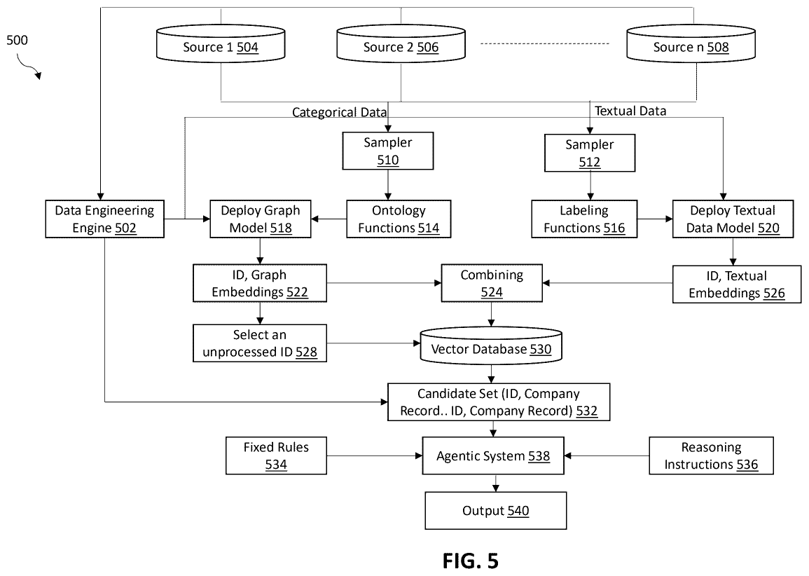

FIG. 5 illustrates a process flow for performing entity resolution, in accordance with an exemplary implementation. As illustrated in FIG. 5, the process flow 500 includes a Data Engineering Engine 502, a plurality of data sources (source1 504, source2 506, . . . , source n 508), a sampler 510, a sampler 512, an ontology 514, labeling functions 516, a graph model 518, a textual data model 520, a vector database 530, a candidate set 532, fixed rules 534, reasoning instructions 536, an agentic system 538, an output 540, and further includes steps depicting an ID and graph embeddings 522, combining 524, an ID and textual embeddings 526, and selecting an unprocessed ID 528. A candidate from the candidate set 532 may include an identification of a company with the company details, which may be represented as (ID, company record).

In an exemplary implementation, the process flow 500 provides a solution for named entity resolution for removing ambiguity and determining the correct entities that represent the same entity. The process flow 500 combines similar entities data in a group or cluster which represent the same named entity in a single-view representation. The process flow 500 is able to handle mixed modal input (e.g., input in different data formats), sparsity (e.g., some unavailable or missing data), and different standardized data. Further, the system 500 uses neural network models to create combined embeddings to integrate information from both categorical and textual data to form a comprehensive representation of each entity.

In an exemplary implementation, a plurality of data sources (source 1 504, source 2 506, . . . , source n 508) may include internal data sources and external data sources. For example, the external data sources may be third-party data provider terminals. Further, the internal data sources may be such as, but not limited to, within the organization's enterprise and network. In an exemplary implementation, the plurality of data sources provides information for an entity (e.g., company) such as company names, addresses, URLs, location of the company, ZIP, city, state, and country. In an exemplary implementation, the plurality of data sources provides information for an entity (e.g., person) such as a person's name, addresses, location, city, and state. The plurality of data sources may provide data in different formats and schemas.

In an exemplary implementation, the received data from the plurality of data sources may be categorized such as, but not limited to, textual data and categorical data. The categorical data may include such as, but not limited to, categorical location features for an entity, such as ZIP code, city, state, and country. The textual data may include, such as, but not limited to, name, address, and URL for the entity. The categorical data and textual data are associated with each-other for the same entity (e.g., company). Further, for an entity, comprising the textual data and the categorical data a unique identifier (ID) is assigned.

In an exemplary implementation, the received data from the plurality of data sources may be in different formats and with different length of strings. The received data consists of records sourced from various origins. These records, for example, may be stored at specified Amazon S3 file locations. The received data prior to storage may be processed using distributed systems such as, but not limited to, Apache Spark. The distributed system is utilized for efficient handling and transformation of large datasets.

Further, the data engineering engine 502 processes the integration of raw datasets sourced from both the external data sources (e.g., financial data providers and similar) and internal data sources (e.g., enterprise data, company data, etc.) associated with the entities. The data engineering engine 502 may perform two primary operations. The first operation is to consolidate disparate datasets into a unified dataset. Second operation is to normalize the unified dataset to ensure its suitability for subsequent tasks. In an exemplary implementation, normalization includes cleaning and preprocessing of the textual attributes, such as company names, addresses, and URLs, to enhance data quality and consistency. In an exemplary implementation, the data engineering engine 502 processes the textual attributes and/or categorical attributes or both.

As shown in FIG. 5, the process flow 500 includes sampler 510 and sampler 512. In an exemplary implementation, the sampler 510 and sampler 512 may process the received categorical data and textual data separately. In yet another exemplary implementation, the system 500 may include a single or plurality of samplers. The plurality of samplers may process the received categorical data and textual data from the plurality of sources simultaneously or separately.

The samplers 510 and 512 take sample data from the received categorical data and textual data from the plurality of data sources. Training the neural network models on the entire dataset collected from multiple data sources can be computationally intensive. To address this, a sampling strategy is used that extracts relevant sample data from the large dataset, meeting two primary criteria. The first criteria being cardinality coverage in which the sample is designed to encompass nearly all cardinalities present in the large dataset. For instance, if the large dataset contains a certain number of unique ZIP codes, the sample data should reflect the same diversity in ZIP codes. The second criterion being relationship coverage in which the sample data may include each type of relationship found in the large dataset. For example, if there is a relationship between ZIP code and revenue in the large dataset, the sample data should also capture this relationship. By obtaining a representative sample data that meets these criteria, the neural network models, such as the graph model 518 and the textual data model 520, may be efficiently trained on this smaller dataset. In an exemplary implementation, the trained graph model 518 may then be used to evaluate GNN embeddings across the large dataset, thereby ensuring that the embeddings are both comprehensive and representative of the original data. In this way, the sample data are chosen to capture the full cardinality and variability of the original dataset, ensuring that the model learns a comprehensive representation.

In an exemplary implementation, the sampler 512 is configured for processing the textual data such as company name, address, URL to capture sufficient character variation within these textual attributes ensuring robust and comprehensive sample data for training the textual data model 520.

Next, the ontology functions 514 process the sample data obtained from sampler 510 based on a data schema for connecting attributes of the categorical data. This sample data representing the categorical data (e.g., ZIP code, city, state, and country) may be used for training and deploying the graph model 518. The graph model 518 may be, for example, but not limited to, a GNN model, which further generates graph embeddings 522. The generated graph embeddings 522 are in single sized embeddings irrespective of any missing or unavailable attributes. Further, the generated graph embeddings 522 may hold the relationships and similarities between categorical data. The graph embeddings 522 corresponding to an entity are assigned to the respective ID of the entity.

Further, the labeling functions 516 are used to process the sample data obtained from the sampler 512. The labeling functions 516 process the sample data to create training data for training and deploying textual data model 520 for name, address, and URL attributes. The textual data model 520 may be applied to the textual embeddings 526 to assign different weights to various attributes. This may allow to prioritize certain features over others based on their importance to the entity resolution task. In an exemplary implementation, the textual data model 520, may be, for example, but not limited to, a Siamese network architecture model, which is based on a neural network architecture. The textual data model 520 may be able to identify similar entities based on the training and/or previous historical data and generate the textual embeddings 526. The generated textual embeddings 526 are in single sized embeddings irrespective of the size of textual data (i.e., short text, long text etc.). The textual embeddings 526 may hold the semantic meaning of the textual data. The textual embeddings 526 corresponding to an entity may be assigned to the respective ID of the entity.

As used herein, GNN models are a class of neural networks designed to operate on graph-structured data. This structure is effective at capturing the dependencies and relationships between nodes (e.g., companies, individuals, or products) in a graph. During the training procedure, the dataset is represented as a graph where nodes correspond to entities (e.g., companies) and edges represent relationships between these entities (e.g., two companies are part of the same corporate group). This graph captures the inherent structure and connectivity of the data. The GNN model learns the embeddings for each node that captures both the node's attributes and its position in the graph. These embeddings are vector representations that encode the node's features and its relational context. The GNN model uses a process called message passing to propagate information across the graph. During each iteration (or layer) of the GNN, nodes aggregate information from their neighbors to update their own embeddings. This allows nodes to incorporate information from their local neighborhood, effectively capturing the graph's structure. Further, the GNN model may have aggregation functions including mean, sum, or max pooling, which combine the features of neighboring nodes. The GNN is trained using a sample graph dataset, which is a representative subset of the full graph. This sample is chosen to capture the full cardinality and variability of the original data, ensuring that the model learns a comprehensive representation. The training process involves optimizing a loss function that measures the difference between the predicted and true node embeddings or labels. This is typically done using gradient descent and backpropagation. Once trained, the GNN model may infer embeddings for the remaining nodes in the full graph. These embeddings are then used in the retrieval step of the entity resolution process to identify potential candidate matches. Further, to handle large-scale graphs, techniques such as sampling and mini-batch training may be employed in the GNN model to efficiently process large graphs without requiring excessive computational resources.

It would be appreciated by the person skilled in the art that the mentioned models and training of the models are given for exemplary purposes, there may be similar or other models and associated training steps based on the implementation of the usages.

Next, the process flow 500 proceeds to combining at 524, where the graph embeddings 522 and textual embeddings 526 are combined to form a comprehensive representation of each entity (‘combined embeddings’). This combined embedding is designed to be robust and complete, even when some attributes are missing, ensuring that the entity resolution process remains effective across a diverse and incomplete set of data. The combined embeddings are created by concatenating the categorical and textual embeddings into a single vector representation. This concatenation involves assigning weights to each type of embedding based on their importance or relevance to the entity resolution task. The weights may be adjusted to emphasize certain attributes over others, allowing the combined embeddings to reflect the most critical features of the entity.

Further, the combined embeddings are robust because they may leverage multiple data modalities, ensuring that the representation is not overly reliant on any single attribute type. This diversity in data sources may help to mitigate the impact of missing information.

Next, the combined embeddings may be stored in a vector database 530 for comparing matching entities across different data sources. The vector database 530 may be, for example, an OpenSearch database.

Next, an unprocessed ID 528 related to an entity is selected for which entity resolution needs to be performed. As used herein, the unprocessed ID 528 refers to a new record entity for which similar candidate records are to be retrieved from the vector database 530.

Next, the data engineering engine 502 preprocesses the unprocessed ID 528 and its embeddings to ensure its suitability for subsequent comparisons with the embeddings stored in the vector database 530. Thereafter, the unprocessed ID 528 and its embeddings are compared with each of the stored graph embeddings 522 and the text embeddings 526 to identify a candidate set. In an exemplary implementation, an ANN search technique may be employed for resolving the unprocessed ID 528. The ANN search is designed to quickly identify stored embeddings records that are similar to the embeddings of the unprocessed ID 528 in the vector database 530. Further, the potential candidate set 532 may be selected based on their proximity in the embeddings space, as determined by the ANN search and similarity function. The potential candidate set may be selected even for missing some attributes. The selected candidate set 532 may be such as, exact match, similar match or partial match, which may be further processed for refining and increasing accuracy. In an exemplary implementation, selecting the potential candidate set 532 may form a cluster or group of candidate entities having similar embeddings with the unprocessed ID 528. The identified candidate set 532 will have records similar to the unprocessed ID 528.

Finally, the process flow 500, displays an output 540, which comprises a relevant candidate set from the identified candidate set 532. The relevant candidate set is identified using an agentic system 538 that is configured based on LLMs. The relevant candidate set is also ranked using the agentic system 538. The determination of relevant candidate sets is a refinement step that involves deploying multiple LLM-powered agents, each guided by predefined/fixed rules 534 and reasoning instructions 536. The agentic system 538 captures intrinsic nuances and distinctions, such as aliases and hierarchical relationships, ensuring a more precise and relevant set of candidate entities. This way, the refinement and the ranking process is a sophisticated approach to entity resolution that leverages advanced techniques in embeddings, ANN search, and LLM-powered decision-making.

The output 540 also displays a similarity score for each relevant candidate from the relevant candidate set. The similarity score is a numerical value that indicates how similar the target entity is to the relevant candidate entity. A higher similarity score suggests that the two are more similar.

In an exemplary implementation, the agentic system 538 is trained using historical data set patterns and exemplary scenarios for determining the relevant candidate set among the clustered candidate set 532. The agentic system 538 is trained to use context-aware decision-making processes for the determination of relevant candidate set for the unprocessed ID 528. For determining the context, the agentic system 538 is trained using exemplary scenarios and historical records using one or more models (e.g., an LLM model and/or an NLP model). The agentic system 538 may work via performing a single intake processing for the candidate set to determine a relevant candidate set for the unprocessed ID 528 thereby reducing the overall computation burden during an operation. The agentic system 538 may be configured to allow for performing “skip-recursive” retrieval techniques, so that not all records need to be compared with every other record. This significantly reduces the computational burden and enables the system to scale effectively. Further, the agentic system 538 may handle incremental entity formation, so that new records arriving at later points in time may be processed discretely. Furthermore, the agentic system 538 may determine whether a new record belongs to an existing entity or should form a new entity, facilitating continuous updates to the entity resolution process.

Next, after determining the relevant entities, the output 540 may display a single-view representation output having relevant entities from the set of clustered candidate entities for the given target entity. The display output may display or provide a target entity and relevant matched entities, along with textual attributes and categorical attributes for resolving the entity duplication or repetition.

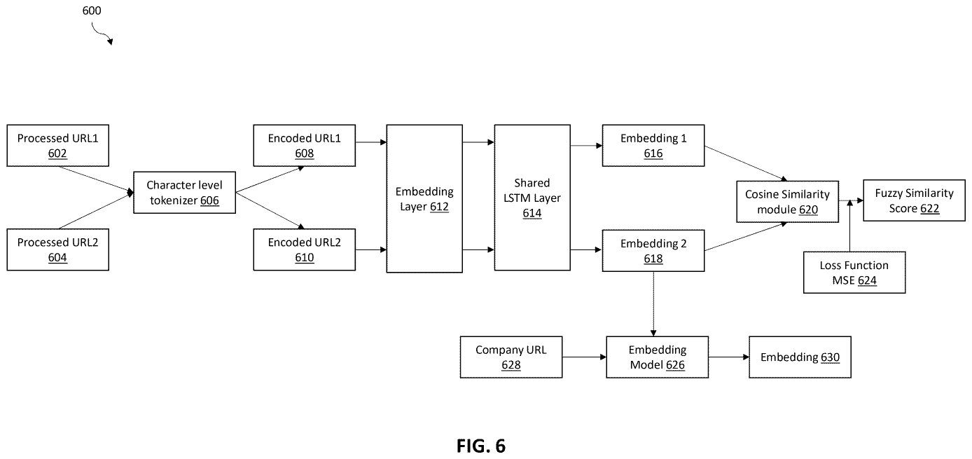

FIG. 6 illustrates an architecture of a system 600 depicting training a neural network model for generating embeddings, in accordance with an exemplary embodiment of the present disclosure. As illustrated in FIG. 6, the system 600 includes a processed URL1 602 and a processed URL2 604, a character level tokenizer 606, an encoded URL1 608, an encoded URL2 610, an embeddings layer 612, a shared long short-term memory (LSTM) layer 614, an embedding1 616, an embedding2 618, a cosine similarity 620, a fuzzy similarity score 622, a loss function MSE 624, an embedding model 626, a company URL 628, and an embedding 630.

In an exemplary implementation, the neural network model is a sequential model which takes two texts as an input (such as the processed URL1 602 and the processed URL2 604) and provides two outputs (such as encoded URL1 608 and encoded URL2 610). The two inputs, processed URL1 602 and processed URL2 604, undergo a character-level tokenization through the character level tokenizer 606. During the character-level tokenization, every character in the input text is converted into a corresponding numeric token.

After character-level tokenization, the sequence of numeric tokens generates encoded URL1 608 and encoded URL2 610. The token sequences (such as encoded URL1 608 and encoded URL2 610) are then passed through the embedding layer 612, which transforms each numeric token into a dense vector representation.

Thereafter, the dense vector representation flows into a shared long short-term memory network (LSTM layer 614) to generate two comparable embeddings such as Embedding1 616 and Embedding2 618, each capturing the sequential relationships and context of its respective input text (such as processed URL1 602 and processed URL2 604). Both subnetworks, the embedding layer 612 and

LSTM layer 614, share the same weights, ensuring that they learn the same feature representations for the input texts. This is crucial for ensuring that the comparison between the two inputs is consistent.

Next, the model calculates how similar these two embeddings (such as Embedding1 616 and Embedding2 618) are by passing them into the cosine similarity 620. The cosine similarity 620 computes a similarity score. The similarity score may be between −1 and 1 (where 1 indicates identical or near identical, and −1 indicates strong dissimilarity). In some implementations, a Fuzzy similarity score 622 may further refine the similarity calculation by incorporating additional heuristics or domain-specific metrics.

During training, a mean squared error (MSE) or mean absolute error (MAE) loss function 624 is used, which penalizes the network for incorrect similarity predictions. This encourages the network to produce embeddings that accurately reflect the similarity between input texts (such as processed URL1 602 and the processed URL2 604). The subnetworks' weights are iteratively adjusted to minimize this loss, thereby improving the trained model's ability to determine whether two textual inputs refer to the same or different entities.

Once training of the neural network model is complete, the embedding model 626 can convert the company URL 628 or other text input into the embedding 630.

In an exemplary implementation, the neural network may be, for example a Siamese network, which is a type of neural network architecture that consists of two or more identical subnetworks. These subnetworks share the same parameters and weights, allowing them to process two different inputs in parallel and learn a similarity between them. Further, since the neural network has learned from a shared representation space, embeddings for texts that are closely related (for example, variations of the same URL) will lie closer together, while unrelated texts will appear farther apart. The embeddings can be stored in a vector database or used directly in downstream tasks such as entity resolution.

By matching or clustering texts based on their proximity in the embeddings space, the system can accurately identify if two textual fields, including URLs, likely refer to the same underlying entity. This approach is especially powerful in large-scale systems, where quick and accurate similarity checks are vital for data integration and de-duplication.

The present disclosure provides several advantages as given below. The present disclosure provides a method for providing single-view representation for a given or searched entity (e.g., company, person, etc.). The method processes mixed-modal input in different formats, standards, sparsity, and hierarchy to perform entity resolution. Further, based on the given priority or weightage, the method ranks the potential candidate entities against the given entity resolution. This approach uses sampling, a GNN model, an NLP model, and/or an LLM for comparing attributes of the target entity and candidate entities using embeddings for determining the relevant matched entities, which requires less resource computation. The present method provides a solution in which all candidates for a searched entity can be processed in a single intake, thereby reducing the overall computation burden and enabling skip recursion. Further, the present method breaks the limitations in pairwise computation and provides an opportunity to scale. The present method may process any number of unseen records discretely. Further, the present solution may determine, via the agent framework, whether the new record belongs to an existing entity or whether there is a requirement to form a new entity.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims. For instance, the invention has been described with reference to an indoor or office environment; however, the invention is not intended to be limited to indoor environments and may also be implemented in outdoor environments.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to perform entity resolution is disclosed. The instructions include executable code which, when executed by a processor 104, may cause the processor 104 to receive a set of data from at least one source, wherein the set of data is associated with a set of entities; extract a first set of attributes and a second set of attributes from the received set of data, wherein each of the first set of attributes is associated with at least one second set of attributes; generate using at least one trained model, a first set of embeddings for the first set of attributes and a second set of embeddings for the second set of attributes; store the generated first set of embeddings and the generated second set of embeddings in a database; select a target entity from the set of entities; compare a set of target embeddings associated with the target entity with the stored first set of embeddings and the stored second set of embeddings; cluster a set of candidate entities that are similar to the selected target entity based on the comparison; and determine at least one entity from the clustered set of candidate entities based on at least one from among a set of agent models, and a set of predefined instructions.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method for performing entity resolution, the method being implemented by at least one processor, the method comprising:
receiving, by the at least one processor, a set of data from at least one data source, wherein the set of data comprises a plurality of attributes associated with a set of entities;
extracting, by the at least one processor, a first set of attributes and a second set of attributes from the plurality of attributes, wherein each attribute from the first set of attributes is associated with at least one attribute from the second set of attributes and corresponds to an entity;
generating, by the at least one processor using at least one trained machine learning-based model, a first set of embeddings for the first set of attributes and a second set of embeddings for the second set of attributes, wherein the generating of the first set of embeddings and the second set of embeddings includes populating missing categorical attributes with imputed values so as to generate a complete representation, and wherein the generating of the first set of embeddings and the second set of embeddings includes using the trained machine learning-based model to convert the received set of data into tokenized numeric data, wherein the at least one trained machine learning-based model includes a first trained model that is trained to identify textual attributes and generate textual embeddings, and wherein the at least one trained machine learning-based model further includes a second trained model that is trained to identify categorical attributes and generate graph node embeddings;
combining, by the at least one processor, the generated first set of embeddings and the generated second set of embeddings to generate a combined embedding by synthesizing categorical and textual embeddings into a single representation, wherein the combined embedding represents the entity;
storing, by the at least one processor, the combined embedding in a database;
selecting, by the at least one processor, a target entity from the set of entities;
identifying, by the at least one processor, a target set of embeddings associated with the selected target entity from the stored combined embedding;
comparing, by the at least one processor, the target set of embeddings with the stored combined embedding;
determining, by the at least one processor via an agent framework, a set of candidate entities based on a result of the comparing, wherein the determining of the set of candidate entities includes deploying a plurality of large language model (LLM) powered agents that capture intrinsic nuances associated with the set of candidate entities to identify the set of candidate entities from the set of entities; and
clustering, by the at least one processor, the set of candidate entities.

2. The method as claimed in claim 1, wherein the set of data comprises a plurality of bibliographic details of the set of entities.

3. (canceled)

4. The method as claimed in claim 1, wherein the method further comprises:
determining, by the at least one processor, a set of relevant candidate entities from the set of candidate entities using the agent framework that is configured based on the LLM; and
ranking, by the at least one processor, the set of relevant candidate entities using the agent framework.

5. The method as claimed in claim 4, wherein the method further comprises:
displaying, by the at least one processor, a similarity score for each relevant candidate entity from the ranked set of relevant candidate entities.

6. The method as claimed in claim 1, wherein the first set of attributes comprises at least one from among a company name, an address, and a uniform resource locator (URL).

7. The method as claimed in claim 1, wherein the second set of attributes comprises at least one from among a location, a ZIP code, a city, a state, and a country.

8. The method as claimed in claim 1, wherein the first trained model is further trained using historical data of the first set of attributes and the second trained model is further trained using historical data of the second set of attributes.

9. A computing device configured to perform entity resolution, the computing device comprising:
a processor,
a memory storing instructions; and
a communication interface coupled to each of the processor and the memory,
wherein the processor is programmed to cooperate with the instructions to perform operations comprising:
receiving a set of data from at least one data source, wherein the set of data comprises a plurality of attributes associated with a set of entities;
extracting a first set of attributes and a second set of attributes from the plurality of attributes, wherein each attribute from the first set of attributes is associated with at least one attribute from the second set of attributes and corresponds to an entity;
generating using at least one trained machine learning-based model, a first set of embeddings for the first set of attributes and a second set of embeddings for the second set of attributes, wherein the generating of the first set of embeddings and the second set of embeddings includes populating missing categorical attributes with imputed values so as to generate a complete representation, and wherein the generating of the first set of embeddings and the second set of embeddings includes using the trained machine learning-based model to convert the received set of data into tokenized numeric data, wherein the at least one trained machine learning-based model includes a first trained model that is trained to identify textual attributes and generate textual embeddings, and wherein the at least one trained machine learning-based model further includes a second trained model that is trained to identify categorical attributes and generate graph node embeddings;
combining the generated first set of embeddings and the generated second set of embeddings to generate a combined embedding by synthesizing categorical and textual embeddings into a single representation, wherein the combined embedding represents the entity;
storing the combined embedding in a database;
selecting a target entity from the set of entities;
identifying a target set of embeddings associated with the selected target entity, from the stored combined embedding;
comparing the target set of embeddings with the stored combined embedding;
determining, via an agent framework, a set of candidate entities based on a result of the comparing, wherein the determining of the set of candidate entities includes deploying a plurality of large language model (LLM) powered agents that capture intrinsic nuances associated with the set of candidate entities to identify the set of candidate entities from the set of entities; and
clustering the set of candidate entities.

10. The computing device as claimed in claim 9, wherein the set of data comprises a plurality of bibliographic details of the set of entities.

11. (canceled)

12. The computing device as claimed in claim 9, wherein the operations further comprise:
determining a set of relevant candidate entities from the set of candidate entities using the agent framework that is configured based on the LLM; and
ranking the set of relevant candidate entities using the agent framework.

13. The computing device as claimed in claim 12, wherein the operations further comprise:
displaying a similarity score for each relevant candidate entity from the ranked set of relevant candidate entities.

14. The computing device as claimed in claim 9, wherein the first set of attributes comprises at least one from among a company name, an address, and a uniform resource locator (URL).

15. The computing device as claimed in claim 9, wherein the second set of attributes comprises at least one from among a location, a ZIP code, a city, a state, and a country.

16. The computing device as claimed in claim 9, wherein the first trained model is further trained using historical data of the first set of attributes and the second trained model is further trained using historical data of the second set of attributes.

17. A non-transitory computer readable storage medium storing instruction for performing entity resolution, the instructions comprising executable code which when executed by a processor, causes the processor to perform operations comprising:
receive a set of data from at least one data source, wherein the set of data comprises a plurality of attributes associated with a set of entities;
extract a first set of attributes and a second set of attributes from the plurality of attributes, wherein each attribute from the first set of attributes is associated with at least one attribute from the second set of attributes and corresponds to an entity;
generate using at least one trained machine learning-based model, a first set of embeddings for the first set of attributes and a second set of embeddings for the second set of attributes, wherein the generating of the first set of embeddings and the second set of embeddings includes populating missing categorical attributes with imputed values so as to generate a complete representation, and wherein the generating of the first set of embeddings and the second set of embeddings includes using the trained machine learning-based model to convert the received set of data into tokenized numeric data, wherein the at least one trained machine learning-based model includes a first trained model that is trained to identify textual attributes and generate textual embeddings, and wherein the at least one trained machine learning-based model further includes a second trained model that is trained to identify categorical attributes and generate graph node embeddings;
combine the generated first set of embeddings and the generated second set of embeddings to generate a combined embedding by synthesizing categorical and textual embeddings into a single representation, wherein the combined embedding represents the entity;
store the combined embedding in a database;
select a target entity from the set of entities;
identify a target set of embeddings associated with the selected target entity, from the stored combined embedding;
compare the target set of embeddings with the stored combined embedding;
determine, via an agent framework, a set of candidate entities based on a result of the comparing, wherein the determining of the set of candidate entities includes deploying a plurality of large language model (LLM) powered agents that capture intrinsic nuances associated with the set of candidate entities to identify the set of candidate entities from the set of entities; and
cluster the set of candidate entities.

18. (canceled)

19. The storage medium as claimed in claim 17, wherein the operations further comprise:
determining a set of relevant candidate entities from the set of candidate entities using the agent framework that is configured based on the LLM; and
ranking the set of relevant candidate entities using the agent framework.

20. The storage medium as claimed in claim 17, wherein the operations further comprise:
displaying a similarity score for each relevant candidate entity from the ranked set of relevant candidate entities.
